(19) United States
(12) Patent Application Publication
(10) Pub. No.: US 2003/0085256 A1
(43) Pub. Date: May 8, 2003

(54) Semiconductor manufacturing apparatus and method, semiconductor device and electronic device

(76) Inventors: Naoji Senba, Tokyo (JP); Koji Soejima, Tokyo (JP)

Correspondence Address: KATTEN MUCHIN ZAVIS ROSENMAN, 575 MADISON AVENUE, NEW YORK, NY, 10022-2585, US

(21) Appl. No.: 10/281,567

(22) Filed: Oct. 28, 2002

(30) Foreign Application Priority Data
Nov. 2, 2001 (JP) 2001-337917

(51) Int. Cl. B23K 20/12

(52) U.S. Cl. 228/112.1

(57) ABSTRACT

A semiconductor manufacturing apparatus for manufacturing a highly versatile semiconductor device includes a holder for releasably embracing and holding a substrate having first and second sides on which first and second bonding pads, respectively, are provided; a bonding tool for wire-bonding the first and second bonding pads; and a bonding head, which has the bonding tool mounted thereon, for driving the bonding tool in three dimensions and rotating the bonding tool about an axis that is perpendicular to the central axis of the bonding tool.

### FIELD OF THE INVENTION

This invention relates to a semiconductor manufacturing apparatus and method, a semiconductor device and an electronic device. More particularly, the invention relates to a semiconductor manufacturing apparatus and method for manufacturing a highly versatile semiconductor device at reduced cost, the semiconductor device, and an electronic device having this semiconductor device.

### BACKGROUND OF THE INVENTION

Reductions in the size and weight of electronic devices have been accompanied by the packaging of semiconductor devices at higher densities. A known method of achieving a higher density of semiconductor devices is to stack a plurality of semiconductor bare chips within the semiconductor device. This stack of semiconductor bare chips is used for connecting the bare chips to one another or for mounting them on a motherboard. In a semiconductor device known in the art, a thin-film re-wiring layer is formed on the side faces of the unit composed of the stacked semiconductor bare chips in order to electrically interconnect the stacked chips.

Reference will be had to the drawings to describe a method of manufacturing a conventional semiconductor device in which such a thin-film re-wiring layer is formed.

FIGS. 11 to 14 are process sectional or perspective views schematically illustrating a method of manufacturing a semiconductor device according to one example of the prior art.

As shown in FIGS. 11A and 11B, a thin-film insulating layer 105 is formed on the top surface (or on both the top and bottom surfaces if necessary) of a wafer 101 that has already undergone diffusion (or a characteristic check) and in which a chip 102 has been formed. The thin-film insulating layer 105 and a chip electrode 106 are removed by lithography at a location necessary for the formation of an embedded electrode 104, then the embedded electrode 104 is formed at this location. Next, a thin-film conductor layer 103 for electrical and mechanical connection to the chip electrode 106 is formed on top of the embedded electrode 104 and thin-film insulating layer 105. Next, in order to obtain a discrete chip and promote dicing, part of the thin-film insulating layer 105 and thin-film conductor layer 103 is removed using lithography, thereby forming a dicing line 107.

Next, as shown in of FIG. 12A, a dicing portion 108 is subjected to full-cut dicing along the dicing lines using a diamond blade or the like, thereby segmenting the wafer into the individual chip 102. The chip 102 that has undergone full-cut dicing only has diced surfaces 109 exhibiting a high surface roughness, as shown in of FIG. 12B. These surfaces are not level surfaces on which a thin film can be formed.

Next, as shown in FIG. 13A, the individual chips 102 are juxtaposed with their end faces made aligned, the thin-film conductor layers of mutually adjacent chips 102 are secured to each other, and the end faces [the surfaces that correspond to the diced surfaces 109 in FIG. 12B] of the secured chip unit (referred to as a “semiconductor device” below) are ground or polished until thin films can be formed on them. (By way of example, grinding or polishing is applied until the surface roughness of ground and polished surfaces 110 falls below 0.1 μm.)

Next, as shown in FIG. 13B, an end-face insulating layer 111 is formed as the top layer on the ground and polished surfaces of the semiconductor device, after which lithography is used to remove the end-face insulating layer 111 until at the portions corresponding to the thin-film conductor layers 103 until the thin-film conductor layers 103 are exposed, thereby forming end-face insulating-layer apertures 112. Next, by using lithography and a metal-forming technique (vapor-deposition sputtering, etc.), an end-face thin-film conductor layer 113 that will serve as end-face thin-film wiring is formed on the end-face insulating layer 111 of the semiconductor device. As a result, the end-face thin-film conductor layer 113 is electrically and mechanically connected to the thin-film conductor layers 103 via the end-face insulating-layer apertures 112.

FIG. 14A is a perspective view showing a completed article 114 having the end-face thin-film wiring formed on the semiconductor device. FIG. 14B is a perspective view showing a four-stage stacked article 115 regarding a three-dimensional semiconductor device in a case where four of the completed articles 114 are stacked.

Thus, a semiconductor device is formed using considerable lithography (at least four times in this example of the prior art) in the above-described semiconductor manufacturing process according to the prior art.

### SUMMARY OF THE DISCLOSURE

Thus, with this conventional method of manufacturing a semiconductor device having end-face wiring, the end-face wiring is formed on the semiconductor device using lithography, alignment between chips, end-face grinding or polishing and a thin-film forming technique. Since lithography is used, enormous resources are required to set up facilities and an establish an environment in which they can be applied. Further, aligning of chips requires highly precise alignment on the order of microns or less and is difficult to achieve. Furthermore, in order to form a thin film on the cut surfaces of the chip end faces, highly precise grinding or polishing providing a surface roughness on the order of microns or less is necessary and this also is not easy to implement. Thus, the prior art involves major technological problems in terms of resources, alignment and attainment of high surface smoothness. As a consequence, the semiconductor device manufactured by the conventional method has poor connection reliability and is high in cost.

Accordingly, it is an object of the present invention to provide a semiconductor device manufacturing apparatus and method whereby a highly versatile, highly reliable semiconductor device can be obtained, as well as the semiconductor device and an electronic device using this semiconductor device.

Another object of the present invention is to provide a semiconductor device manufacturing apparatus and method whereby a semiconductor device can be manufactured with fewer process steps and at lower cost, as well as the semiconductor device and an electronic device using this semiconductor device.

The foregoing objects are attained by a semiconductor manufacturing apparatus in accordance with a first aspect of the present invention, comprising: a holder for releasably embracing and holding a substrate having first and second bonding pads on first and second surfaces thereof, respectively, said second surface being opposite the first surface; a bonding tool for wire-bonding the first bonding pad and the second bonding pad by a wire; and a bonding head, having said bonding tool mounted thereon, for driving said bonding tool in three dimensions and rotating the bonding tool about an axis that is perpendicular to a central axis of said bonding tool.

According to another aspect of the present invention, there is provided a semiconductor manufacturing apparatus comprising: a holder for releasably embracing and holding a substrate having a top surface on which a first bonding pad is provided and a bottom surface, which is opposite the top surface, on which a second bonding pad is provided; a first bonding tool disposed on the top surface of the substrate and having a distal end for being directed toward the substrate surface for effecting a bonding connection by a wire to the first bonding pad on the top surface of the substrate, the first bonding tool having a central axis; a second bonding tool disposed on the bottom surface of the substrate and having a distal end for being directed toward the substrate surface for effecting a bonding connection by the wire to the second bonding pad on the bottom surface of the substrate, the second bonding tool having a central axis; a first bonding head, which has the first bonding tool mounted thereon, for driving the first bonding tool in three dimensions and rotating the bonding tool about an axis that is perpendicular to the central axis of the first bonding tool; a second bonding head, which has the second bonding tool mounted thereon, for driving the second bonding tool in three dimensions and rotating the second bonding tool about an axis that is perpendicular to the central axis of the second bonding tool; a first clamper disposed above the first bonding tool for performing drive in three dimensions in association with the first bonding head, controlling feed and severing of the wire and clamping the wire, which has been tensioned between the first and second bonding tools, in a tension-adjustable manner; and a second clamper disposed below the second bonding tool for performing drive in three dimensions in association with the second bonding head, controlling feed and severing of the wire and clamping the wire, which has been tensioned between the first and second bonding tools, in a tension-adjustable manner.

According to another aspect of the present invention, there is provided a semiconductor manufacturing apparatus comprising: a holder for releasably embracing and holding a substrate having a top surface on which a first bonding pad is provided and a bottom surface, which is opposite the top surface, on which a second bonding pad is provided; and a connection tool head that includes: an opening/closing mechanism for opening and closing to releasably hold a wire unit having one or more C-shaped wires, the wire unit having a recess for receiving a side end portion of the substrate; a drive unit for driving the opening/closing mechanism in three dimensions and rotating it about a fixed axis so as to insert the side end portion of the substrate into the recess of the wire unit until the vicinity of the bottom of the recess is reached; and a connecting tool having a connecting tool for effecting a bonding connection between both ends of the wire in the wire unit and corresponding ones of the first and second bonding pads on the top and bottom surfaces of the substrate.

According to another aspect of the present invention, there is provided a method of manufacturing a semiconductor device comprising the steps of: embracing and holding a substrate having first and second bonding pads on first and second surfaces thereof, respectively; making a first bond to the first bonding pad by a wire; laying the wire, while tensioning the same, from the first bonding pad to the corresponding second bonding pad on the second surface of the substrate opposite the first surface by passing the wire over the outside of a side end face of the substrate in the vicinity of the first bonding pad, and making a second bond to the second bonding pad by the wire; and severing the wire after making the second bond.

According to another aspect of the present invention, there is provided a method of manufacturing a semiconductor device comprising the steps of: embracing and holding a substrate having first and second bonding pads on first and second surfaces thereof, respectively; bringing a tensioned wire into abutting contact with a side end face of the substrate, aligning one end of the wire with the first bonding pad, aligning the other end of the wire with the corresponding second bonding pad on the second surface of the substrate opposite the first surface, and bonding both ends of the wire to respective ones of the first and second bonding pads; and severing the wire after performing bonding.

According to a further aspect of the present invention, there is provided a method of manufacturing a semiconductor device comprising the steps of: embracing and holding a substrate having first and second bonding pads on first and second surfaces thereof, respectively; and inserting a side end portion of the substrate into a recess of a wire unit, which has one or more C-shaped wires, until the vicinity of the bottom of the recess is reached, aligning both ends of the wire unit with corresponding ones of the first and second bonding pads on the first and second surfaces, respectively, of the substrate, and bonding the wire unit to the first and second bonding pads.

According to a further aspect of the present invention, there is provided a semiconductor device comprising: one or more first bonding pads disposed on a first surface of a substrate; one or more second bonding pads corresponding electrically to the first bonding pad and disposed on a second surface of the substrate opposite the first surface; and one or more wires connected to the first bonding pad and connected from the first bonding pad to the second bonding pad by being passed over the outside of a side end face of the substrate.

According to a further aspect of the present invention, there is provided a semiconductor device comprising: one or more first bonding pads disposed on a first surface of a substrate; one or more second bonding pads corresponding electrically to the first bonding pad and disposed on a second surface of the substrate opposite the first surface; and a wire unit having one or more C-shaped wires, the wire unit having a recess for receiving a side end portion of the substrate; wherein the side end portion of the substrate is inserted into a recess of the wire unit, a certain wire is bonded at one end to the first bonding pad and at the other end to the second bonding pad.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a schematic view illustrating the structure of a semiconductor manufacturing apparatus according to a first embodiment of the present invention;

FIGS. 2A, 2B and 2C are a first half of a process diagram schematically illustrating operation of the semiconductor manufacturing apparatus according to the first embodiment;

FIGS. 3A and 3B are a second half of a process diagram schematically illustrating operation of the semiconductor manufacturing apparatus according to the first embodiment;

FIG. 4 is a schematic view illustrating the structure of a semiconductor manufacturing apparatus according to a second embodiment of the present invention;

FIGS. 5A and 5B are a first half of a process diagram schematically illustrating operation of the semiconductor manufacturing apparatus according to the second embodiment;

FIGS. 6A and 6B are a second half of a process diagram schematically illustrating operation of the semiconductor manufacturing apparatus according to the second embodiment;

FIG. 7 is a schematic view illustrating the structure of a semiconductor manufacturing apparatus according to a third embodiment of the present invention;

FIGS. 8A, 8B and 8C are a first half of a process diagram schematically illustrating operation of the semiconductor manufacturing apparatus according to the third embodiment;

FIGS. 9A and 9B are a second half of a process diagram schematically illustrating operation of the semiconductor manufacturing apparatus according to the third embodiment;

FIG. 10 is a sectional view illustrating the structure of a semiconductor manufacturing apparatus according to a fourth embodiment of the present invention;

FIGS. 11A and 11B are a first part of a process sectional view schematically illustrating a method of manufacturing a semiconductor device according to an example of the prior art;

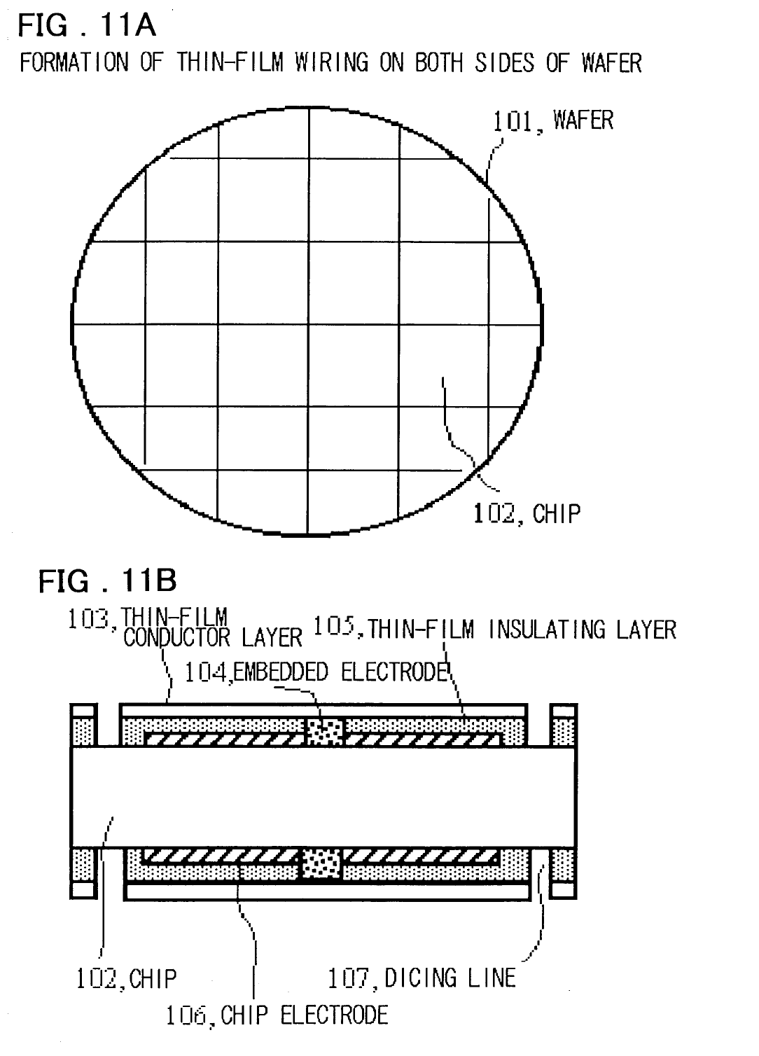

FIGS. 12A and 12B are a second part of a process sectional view schematically illustrating a method of manufacturing a semiconductor device according to the example of the prior art;

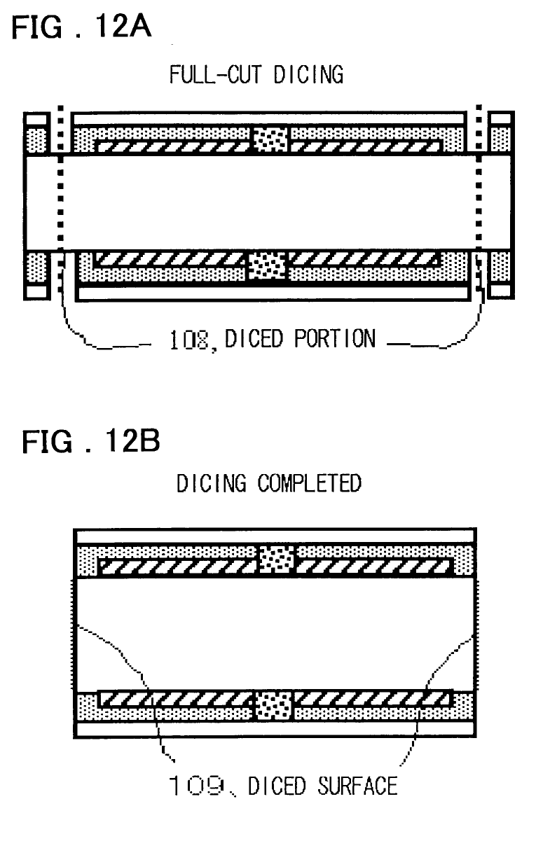

FIGS. 13A and 13B are a third part of a process sectional view schematically illustrating a method of manufacturing a semiconductor device according to the example of the prior art; and

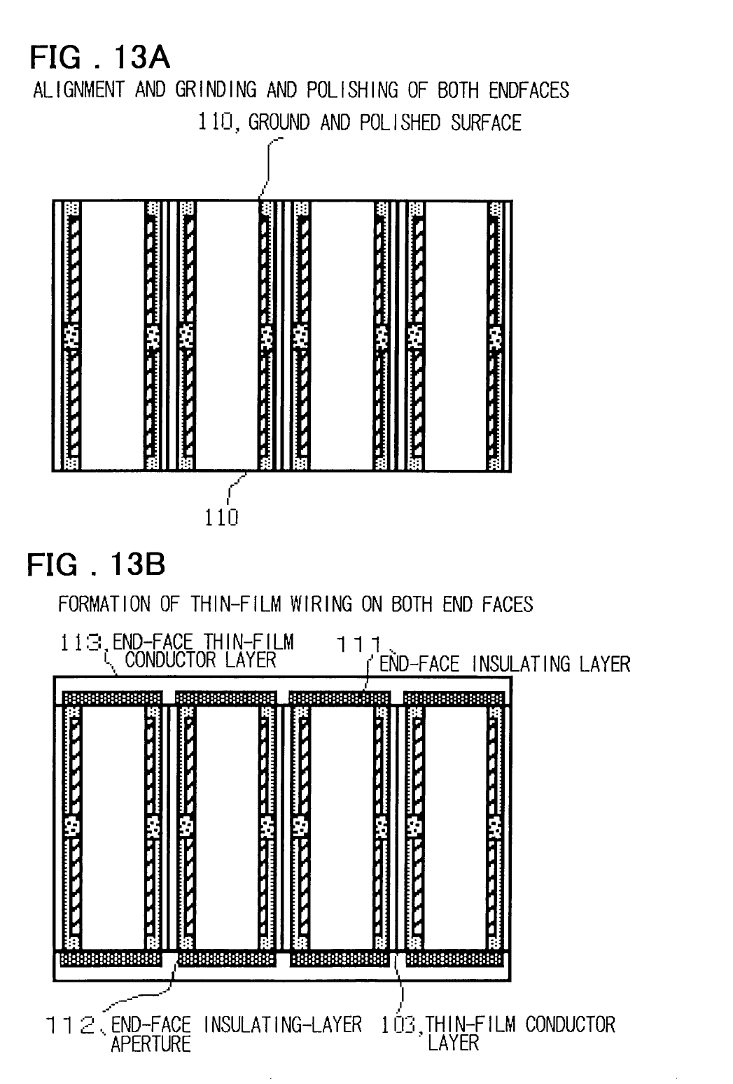

FIGS. 14A and 14B are a fourth part of a process perspective view schematically illustrating a method of manufacturing a semiconductor device according to the example of the prior art.

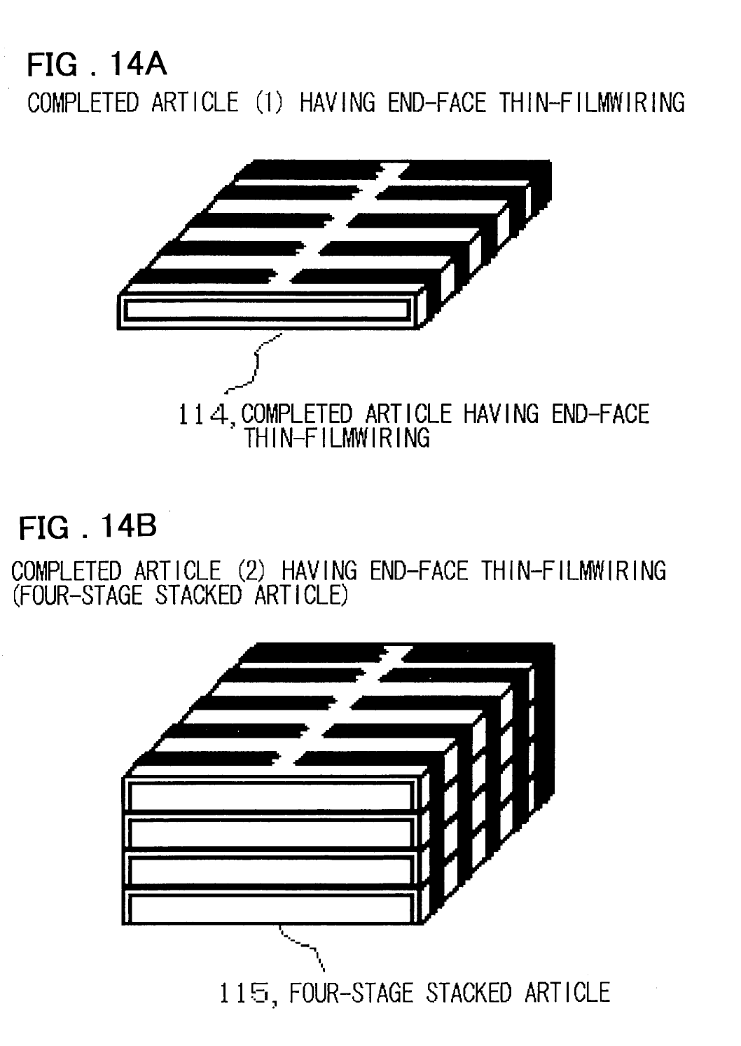

### PREFERRED EMBODIMENTS OF THE INVENTION

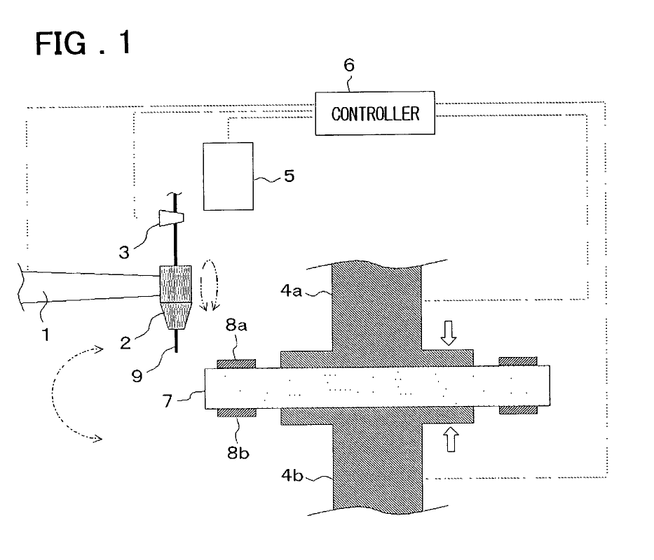

In a preferred embodiment of the present invention, a semiconductor manufacturing apparatus includes a holder (4a and 4b in FIG. 1) for releasably embracing and holding a substrate (7 in FIG. 1) having first and second bonding pads (8a and 8b, respectively, in FIG. 1) on respective ones of both sides thereof; a bonding tool (2 in FIG. 1) for performing wire bonding between the first bonding pad (8a in FIG. 1), which is disposed on one side of the substrate, and the second bonding pad, which is disposed on the side of the substrate opposite the one side, by a wire (9 in FIG. 1); and a bonding head (1 in FIG. 1), which has the bonding tool (2 in FIG. 1) mounted thereon, for actuating the bonding tool in three dimensions and rotating the bonding tool about an axis that is perpendicular to a central axis of the bonding tool. As a result of this structure, fewer resources are required and the number of processes can be reduced.

Preferred embodiments of the present invention will now be described with reference to the drawings.

For a description of a first embodiment, reference will be had to FIG. 1, which is a schematic view illustrating the structure of a semiconductor manufacturing apparatus.

The semiconductor manufacturing apparatus includes a bonding head 1, a bonding tool 2, a clamper 3, a holder 4, a camera tool 5 and a controller 6.

The bonding head 1 is a mechanism on which the bonding tool 2 is mounted. Based upon control information from the controller 6, the bonding head 1 drives the bonding tool 2 in three dimensions (along X, Y and Z directions) in operative association with the clamper 3 in such a manner that the bonding tool will traverse both sides of a double-sided bare chip 7 and outside the side face thereof, and rotates the bonding tool 2 about an axis that is perpendicular to the central axis of the bonding tool (i.e., a θ axis, where θ is the angle formed by the X axis and central axis). This drive shall be referred to as “XYZθ-axis drive” below. Further, owing to XYZθ-axis drive, the bonding head 1 is capable of operating in such a manner that the central axis of the bonding tool 2 mounted thereon may be pointed in any direction, namely 360° about the θ axis. Further, the bonding head 1 cooperates with the holder 4 when the bonding pads are positioned with respect to the double-sided bare chip 7.

The bonding tool 2 is for performing bonding between the bonding pads 8a and 8b of the double-sided bare chip 7 using a wire 9. The tip of the bonding tool 2 is conically shaped and is formed to have an opening (not shown) through which the wire 9 (e.g., of diameter 10 μm) is passed. There are other cases where a wedge tool having a wedge-shaped tip is used. The bonding tool 2 is equipped with an ultrasonic transmitter, spring and voltage-controlled oscillator or heater so that the wire 9 can be subjected to heating, ultrasonic vibration, pressure, scrubbing or welding (or any combination of these). There are cases where the opening through which the wire 9 passes is provided with a substance such as cotton for increasing the passage resistance of the wire, thereby assuring tensioning balance of the wire 9. Another method of assuring tensioning balance of the wire 9 is an air tensioning method through which tensioning balance is assured by blowing compressed air toward the wire 9. An air-jetting hole may be separately provided.

The clamper 3 is a mechanical component for grasping the wire 9 in order to feed or severe the wire 9. The clamper 3 controls the amount of feed of the wire 9, applies tension to the wire 9 and, on the basis of control information from the controller 6, applies drive along the XYZθ axes in operative association with the bonding head 1.

The holder 4 (4a and 4b) embraces and holds the double-sided bare chip 7 from both sides thereof. The holder 4 is divided into a holder 4a on the upper side and a holder 4b on the lower side and is opened and closed (moved up and down) so that the double-sided bare chip 7 can be released. The upper holder 4a and lower holder 4b are not necessarily identical in structure and may be structurally different from each other. The surface of contact between the holder 4 and double-sided bare chip 7 is sized or shaped to cover an active area of the double-sided bare chip 7 other than that occupied by the bonding pads 8a and 8b, and the arrangement is such that the surface of contact will not be subjected to an impact load or excessive load. The holder 4 is so adapted that it can be loaded, heated, cooled, driven along the XYZ axes and rotated about the Z axis (e.g., rotated through an angle of 90° at a time) by electricity, high-pressure air and high-pressure nitrogen, etc., under the control of the controller 6. Further, the holder 4 is not limited to holding of the double-sided bare chip 7 by mechanical means and may hold the bare chip 7 using a vacuum suction or both vacuum suction and mechanical holding means. In particular, since the active area of the double-sided bare chip 7 is embraced and held from both sides, the holder 4 has a combination of a multistage changeover function for changing the raising and lowering speeds of the upper and lower holders and a setting function for setting the raising and lowering speed-changeover positions of the upper and lower holders, or a function for setting maximum load, in order that the double-sided bare chip 7 will not be subjected to impact load and excessive load. This makes extremely fine adjustment of load possible. The holder 4 cooperates with the bonding head 1 when the bonding pads 8a and 8b are positioned with respect to the double-sided bare chip 7. Further, the holder 4 has a function for measuring the thickness of the double-sided bare chip 7 by grasping the double-sided bare chip 7 using the upper holder 4a and lower holder 4b.

The camera tool 5 is a component for monitoring the positions of the central axis of bonding tool 2, bonding pads 8a and 8b, clamper 3, holder 4, wire 9 and bonding portions, etc. The camera tool 5, comprising a CCD or the like, processes image information (video information) acquired by monitoring (measurement), and sends the processed information to the controller 6.

On the basis of a predetermined program, the controller 6 controls the drive of the bonding head 1 and clamper 3 along the XYZθ axes and the various functions (heating, pressurization, ultrasonic output, scrubbing and welding, etc.). Further, on the basis of image information sent from the camera tool 5, the controller 6 corrects the trajectory or position of the bonding head 1 or holder 4 in conformity with the size of the double-sided bare chip 7 and spacing between the pads. Further, the controller 6 may be equipped with a self-teaching function, namely generating means for generating a program that controls the operation of the head (bonding head 1 and clamper 3) or the operation of the holder based upon the size of the double-sided bare chip 7 and video information from the camera tool 5 that has imaged the positions of the bonding heads. The program may be a preset program or a program generated by the generating means.

The double-sided bare chip 7 grasped by the holder 4 does not constitute a part of the semiconductor manufacturing apparatus but is a semiconductor chip having a diffusion layer, insulating layer and a wiring layer such as a metal layer on both its surfaces. One side of the chip has one or more of the upper bonding pads 8a and the opposite side has one or more of the lower bonding pads 8b. The invention may be applied to a circuit substrate, which has bonding pads on both its surfaces, instead of the double-sided bare chip 7.

The wire 9 is a metal wire made of aluminum, gold or copper and may be a coated wire the surface of which is provided with an insulating coating that can be destroyed by heat or ultrasound. (The same holds true in the embodiments below.)

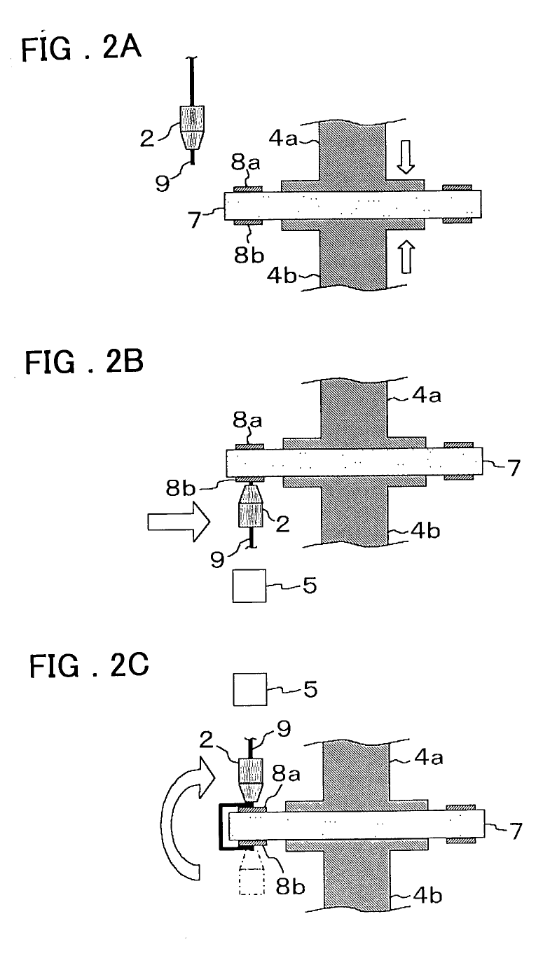

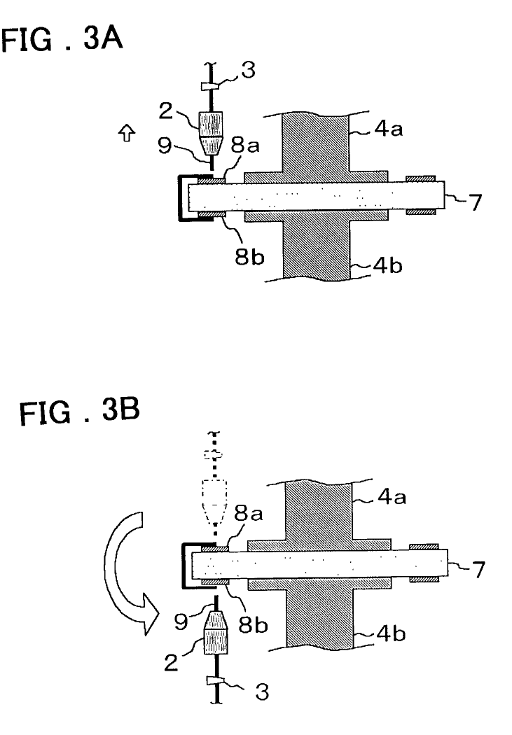

The operation of the semiconductor device manufacturing apparatus and method of the first embodiment will now be described. FIGS. 2 and 3 are process diagrams schematically illustrating the operation of the semiconductor device manufacturing apparatus according to the first embodiment of the present invention.

First, as shown in FIG. 2A, the wire 9 is passed through the bonding tool 2 and the double-sided bare chip 7 is fixed to the holders 4a and 4b without allowing the bonding pads 8a and 8b on both sides of the chip to be covered (step A).

Next, as shown in FIG. 2B, the lower bonding pad 8b of the double-sided bare chip 7 and the bonding tool 2 are aligned, and the wire 9 is partially melted by application of heat, load or ultrasound or a combination thereof from the bonding tool 2, thereby performing a first bond. (In the case of the coated wire, the first bond is made while destroying the coating by heat or ultrasound.) (Step B).

Next, as shown in FIG. 2C, the bonding tool 2 is swung by the outside of the peripheral side surface of double-sided bare chip 7 from the lower bonding pad 8b while tensioning the wire 9, is moved to the upper bonding pad 8a that corresponds to the lower bonding pad 8b, and is aligned with respect to the upper bonding pad 8a. The bonding tool 2 then melts the wire 9 by application of heat, load or ultrasound or a combination thereof, thereby performing a second bond. (In the case of the coated wire, the second bond is made while destroying the coating by heat or ultrasound.) (Step C).

The wire 9 may be tensioned by any of the following methods: (1) a method of tensioning the wire by pressure (air tension) obtained by blowing high-pressure air; (2) a method of tensioning the wire by moving the holder 4 holding the double-sided bare chip; (3) a method of tensioning the wire based upon movement and travelling velocity of the bonding tool 2; (4) a method of tensioning the wire by pulling the wire mechanically using the clamper 3 or a wire feeder; (5) a method of tensioning the wire based upon the relationship between the positions of the bonding head 1 and holder 4; (6) a method of tensioning the wire by increasing the resistance to passage of the wire through a substance that exhibits passage resistance in the bonding tool 2, clamper 3 or wire feeder; and (7) a method of tensioning the wire by moving more than one of the bonding head 1, bonding tool 2, clamper 3 and holder 4.

Here alignment is performed by cooperation between the holder 4 and bonding tool 2 under the control of the controller 6 based upon image information (position information) sent from the camera tool 5. When the second bond is made, the holder 4 also is suitably heated and cooled.

Further, alignment is performed by cooperation between the holders 4a and 4b and bonding tool 2 under the control of a controller (not shown) based upon position information from the camera tool 5. Here the first bond is performed from the lower bonding pad 8b, though it may be performed from the upper bonding pad 8a. When the first bond is made, the holder 4 also is suitably heated and cooled.

Next, as shown in FIG. 3A, the bonding tool 2 is raised slightly (about 100 μm) from the upper bonding pad 8a, after which the wire 9 is grasped by the clamper 3, tensioned by the bonding tool 2 and clamper 3 working together above the double-sided bare chip 7 and severed (torn off) (Step D). This completes the connection of first end-face wiring.

The wire 9 may be severed by any of the following methods: (1) a method of grasping and tearing off the wire using the clamper 3; (2) a method of severing the wire by applying ultrasound to the bonded portion of the wire 9 from the bonding tool 2; (3) a method of severing the wire by an edge attached to the bonding tool 2; and (4) a method of severing the wire from the vicinity of the bonded portion by combining a plurality of the above methods.

Next, as shown in FIG. 3B, the bonding tool 2 is moved from the point above the upper bonding pad 8a relating to the first wiring to the lower bonding pad 8b relating to second end-face wiring by being swung by the outside of the side face of the double-sided bare chip 7 (in the direction opposite that in which the bonding tool 2 was swung at Step C) in order to prepare for connection of the second end-face wiring (e.g., to the neighboring first end-face wiring).

This is followed by repeating steps similar to Steps B to E as necessary, thereby completing all wiring of a single double-sided bare chip 7.

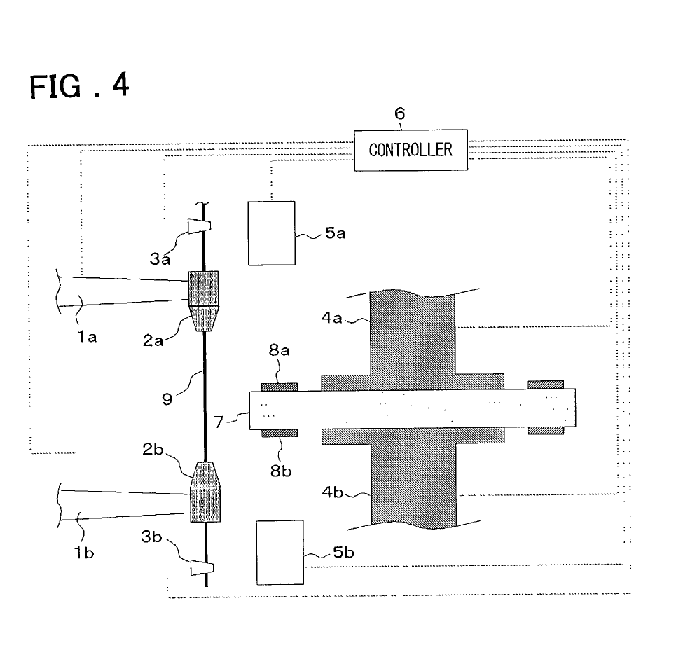

A second embodiment of the present invention will now be described with reference to the drawings. FIG. 4 is a schematic view illustrating the structure of a semiconductor manufacturing apparatus according to the second embodiment.

The holder 4 and controller 6 of the semiconductor manufacturing apparatus according to the second embodiment are similar to those of the first embodiment (see FIG. 1). The semiconductor manufacturing apparatus according to the second embodiment differs from the first embodiment in that two bonding heads 1a and 1b, two bonding tools 2a and 2b, two clampers 3a and 3b and two camera tools 5a and5b are provided and one of each is disposed above the held double-sided bare chip 7 and one of each below the double-sided bare chip 7. Refer to the description of the first embodiment for a description of the functions of the bonding heads 1a and 1b, bonding tools 2a and 2b, clampers 3a and 3b, camera tools 5a and 5b and controller 6.

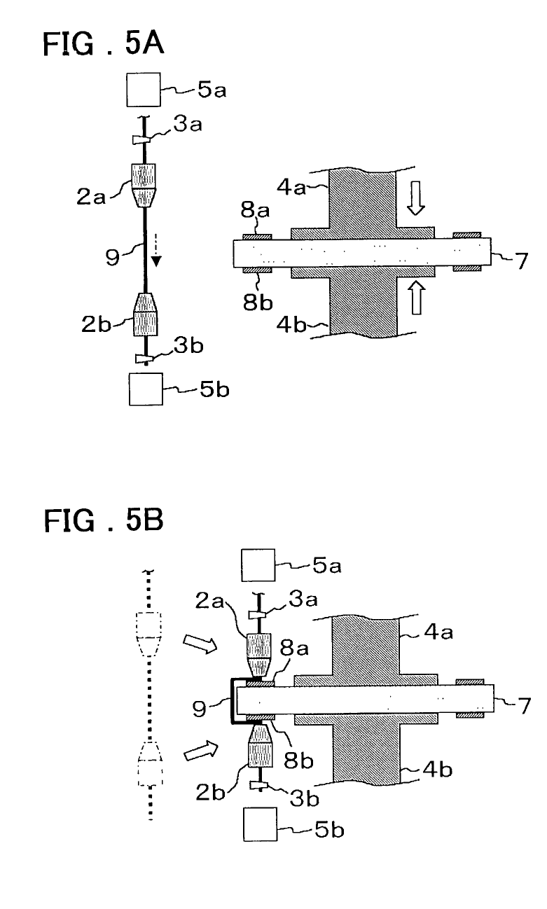

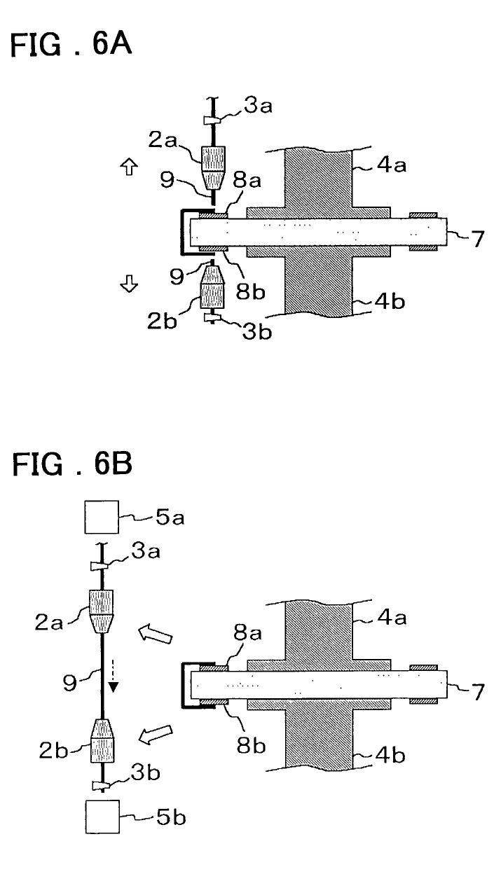

The operation of the semiconductor device manufacturing apparatus and method according to the second embodiment will now be described. FIGS. 5 and 6 are process diagrams schematically illustrating the operation of the semiconductor device manufacturing apparatus according to the second embodiment of the present invention.

First, as shown in FIG. 5A, the wire 9 is supplied from the upper bonding tool 2a to the lower bonding tool 2b and the double-sided bare chip 7 is fixed to the holders 4a and 4b without allowing the bonding pads 8a and 8b on both sides of the chip to be covered (step F). The supply of the wire 9 is performed under the control of the controller 6 based upon position information from the upper camera tool 5a or lower camera tool 5b by adjusting the openings of the upper bonding tool 2a and lower bonding tool 2b so that they will lie on a straight vertical line, opening the upper clamper 3a so that the wire 9 in the upper bonding tool 2a will fall freely or be made to fall forcibly, passing the wire 9 through the opening in the lower bonding tool 2b and then securing the wire by closing the lower clamper 3b. It should be noted that the wire 9 may be passed through the upper bonding tool 2a from the lower bonding tool 2b.

Next, as shown in FIG. 5B, the clampers 3a and 3b are closed and the wire 9 is tensioned suitably. While the wire is being tensioned, the upper and lower bonding tools 2a and 2b, clampers 3a and 3b and camera tools 5a and 5b are moved to the vicinity of the bonding pads 8a and 8b, which are to be operated upon by the bonding tools 2a and 2b, respectively, in such a manner that the middle portion of the wire 9 stretched between the upper and lower bonding tools 2a and 2b is abutted against the peripheral side face of the double-sided bare chip 7. The lower bonding pad 8b of the double-sided bare chip 7 and the lower bonding tool 2b are aligned, the upper bonding pad 8a of the double-sided bare chip 7 and the upper bonding tool 2a are aligned, and the wire is bonded to the bonding pads 8a and 8b by heating, pressurization or ultrasound, or any combination thereof, applied by the bonding tools 2a and 2b. (In the case of the coated wire, the bonding is performed while destroying the coating by heat or ultrasound.) (Step G).

Though the clampers 3a and 3b are in the closed state, they assume a nearly open state conforming to the tension of the wire 9 when the wire contacts the side surface of the double-sided bare chip 7.

Alignment is performed by cooperation between the holder 4 and bonding tools 2a and 2b under the control of the controller 6 based upon position information from the camera tools 5a and 5b. Accordingly, when alignment is performed, a positional adjustment is made so as to widen the clearance between the wire 9 and side end face of the double-sided bare chip 7. When the bonds are made, the holder 4 also is heated and cooled.

Next, as shown in FIG. 6A, the bonding tools 2a and 2b are spaced away slightly (by about 100 μm) from the bonding pads 8a and 8b, respectively, after which the wire 9 is grasped by the clampers 3a and 3b associated with the bonding tools 2a and 2b, tensioned by causing the bonding tools 2a and 2b and clampers 3a and 3b to separate from the double-sided bare chip 7 in operative association, and severed (torn off) (Step H). This completes the connection of first end-face wiring.

Next, at shown at in FIG. 6B, the wire 9 remaining in the lower bonding tool 2b is discharged by opening the clamper 3b, and wire 9 is supplied to the lower bonding tool 2b from the upper bonding tool 2a (Step I). The method of supplying the wire 9 is similar to that used at step F.

This is followed by repeating steps similar to Steps G to I as necessary, thereby completing all wiring of a single double-sided bare chip 7.

Though the operation of the semiconductor manufacturing apparatus of the second embodiment has been described for a case where bonding is performed simultaneously by the upper and lower bonding tools 2a and 2b, it may be so arranged that bonding by one bonding tool is performed after bonding by the other bonding tool.

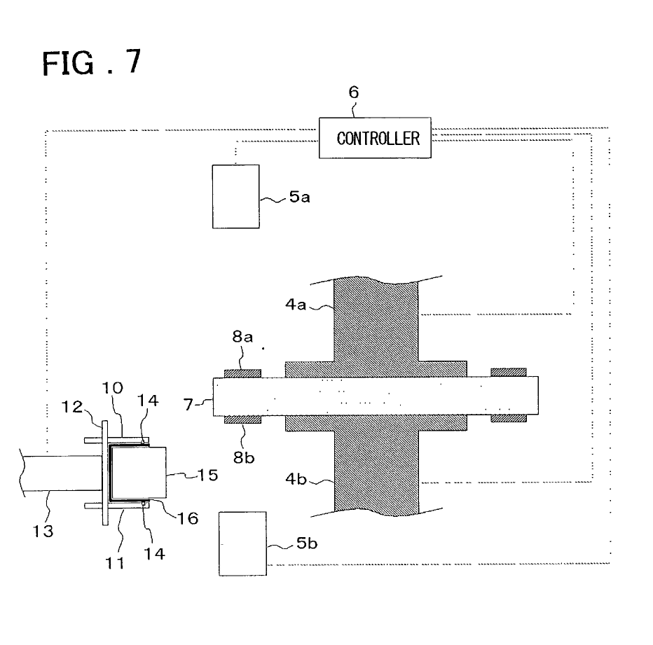

A third embodiment of the present invention will now be described with reference to the drawings. FIG. 7 is a schematic view illustrating the structure of a semiconductor manufacturing apparatus according to the third embodiment.

This semiconductor manufacturing apparatus has connecting tool heads 10 to 14, an inserting head 15, the holder 4, camera tools 5a and 5b and controller 6.

The connecting tool heads 10 to 14 having functions for releasably holding a clip-wire unit 16, aligning the clip-wire unit 16 and the double-sided bare chip 7 and connecting the clip-wire unit 16 to the double-sided bare chip 7. Specifically, the connecting tool heads 10 to 14 are an upper mechanical member 10, a lower mechanical member 11, a guide member 12, an insertion drive member 13 and a connecting tool 14, respectively. The upper mechanical member 10, lower mechanical member 11 and insertion drive member 13 are operated under the control of the controller 6.

The upper mechanical member 10, which is connected to the guide member 12 so as to be movable up and down, has one or more of the connecting tools 14 provided on its lower surface at a position that will correspond to the upper bonding pad 8a of the double-sided bare chip 7 when the chip has been inserted into the clip-wire unit 16.

The lower mechanical member 11, which is connected to the guide member 12 so as to be movable up and down, has one or more of the connecting tools 14 provided on its upper surface at a position that will correspond to the lower bonding pad 8b of the double-sided bare chip 7 when the chip has been inserted into the clip-wire unit 16.

The connecting tool 14 is an ultrasonic transmitter, a spring, a voltage-controlled oscillator or a heater for connecting the bonding pads 8a and 8b of the double-sided bare chip 7 to the corresponding portions of the clip wire in the clip-wire unit 16. The connecting tool 14 applies heat, ultrasonic vibration or pressure, etc., to the clip-wire unit 16.

The guide member 12, which is for guiding sliding motion of the upper mechanical member 10 and lower mechanical member 11, is connected in the vicinity of its midsection to the insertion drive member 13.

Under the control of the controller 6, the insertion drive member 13 drives the clip-wire unit 16, which has been inserted into a cavity formed by the mechanical members, along the XYZθ axes in such a manner that the side face of the double-sided bare chip 7 will fit into the recess of the clip-wire unit 16. The insertion drive member 13 cooperates with the holders 4a and 4b when both ends of the clip-wire unit 16 are brought into alignment with corresponding ones of the bonding pads 8a and 8b on the double-sided bare chip 7. Further, owing to XYZθ-axis drive, the insertion drive member 13 is capable of operating in such a manner that a fixed axis horizontally of the unit that includes the upper mechanical member 10, lower mechanical member 11 and guide member 12 may be pointed in any direction, namely 360° about the θ axis.

The inserting head 15 is for setting the clip-wire unit 16 in the cavity of the unit connecting tools 10 to 14.

Though the clip-wire unit 16 does not constitute a part of this semiconductor manufacturing apparatus, it is obtained by uniting, using resin or the like, C-shaped or U-shaped clip wires (which will become the end-face wiring) whose width between the distal ends thereof corresponds to the thickness of the double-sided bare chip 7. The clip wire itself consists of a metal wire such as of aluminum, gold or copper and may be a coated wire, namely a wire the surface of which is provided with an insulating coating that can be destroyed by heat or ultrasound. If the clip wire is coated wire, then the clip wire may be abutted against the side face of the double-sided bare chip 7.

The holder 4, camera tools 5a and 5b and controller 6 are similar to those of the first embodiment. For a functional description thereof, refer to the teachings of the first embodiment.

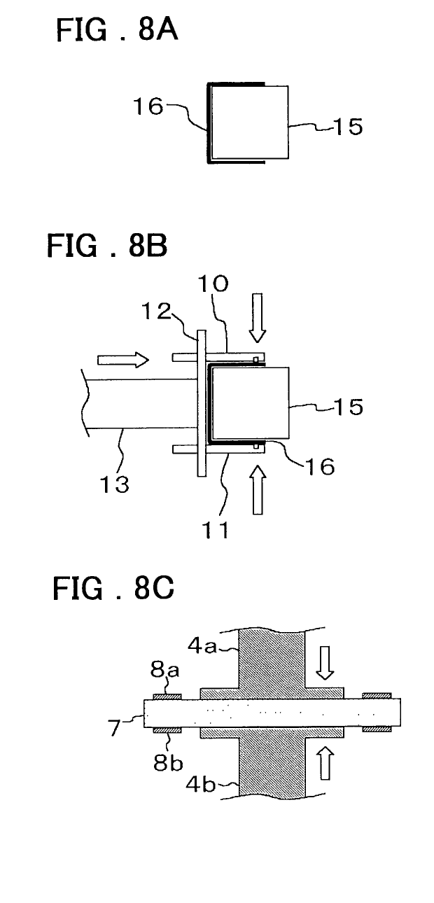

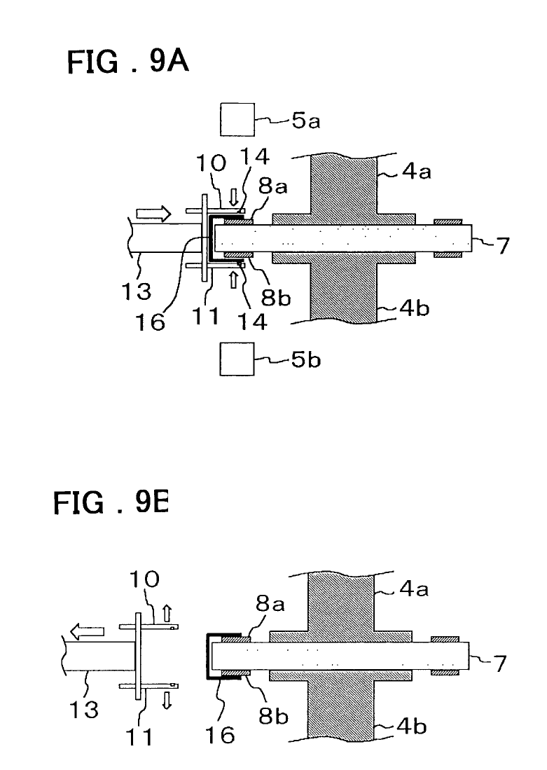

The operation of the semiconductor device manufacturing apparatus and method of manufacturing the semiconductor device according to the third embodiment will now be described. FIGS. 8 and 9 are process diagrams schematically illustrating the operation of the semiconductor device manufacturing apparatus according to the third embodiment of the present invention.

First, as shown in FIG. 8A, the clip-wire unit 16 is set on the inserting head 15 (Step J). Next, as shown in FIG. 8B, the clip-wire unit 16 is set in the cavity defined by the upper mechanical member 10 and lower mechanical member 11, which are associated with the connecting tool head, from the inserting head 15 (Step K).

At this time the upper mechanical member 10 and lower mechanical member 11 are opened and closed uniformly with good balance in dependence upon the width of the clearance between the tips of the clip-wire unit 16 and the thickness of the double-sided bare chip 7, whereby the tension of the clip wire is adjusted automatically.

Meanwhile, as shown in FIG. 8C, the double-sided bare chip 7 is fixed to the holders 4a and 4b (Step L).

Next, as shown at in FIG. 9A, by operating the connecting tool heads 10 to 14, the side end face of the double-sided bare chip 7 is inserted into the recess of the clip-wire unit 16, which has been set between the upper mechanical member 10 and lower mechanical member 11, in such a manner that the side end face will contact the bottom of the recess or reach the vicinity of the bottom of the recess, both ends of the clip-wire unit 16 are aligned with respect to the bonding pads 8a and 8b, the clip-wire unit 16 and double-sided bare chip 7 are grasped by the upper mechanical member 10 and lower mechanical member 11, and the clip-wire unit 16 is connected to the bonding pads 8a and 8b while the coating of the clip-wire unit 16 is destroyed by heat, load or ultrasound or a combination thereof applied by each of the connecting tools 14 (Step M).

When alignment is carried out, the holders 4a and 4b and insertion drive member 13 are operated in association to achieve good balance while the distance between the positions of tips of the clip-wire unit 16 and the positions of the bonding pads 8a and 8b or the distances between the positions of the aforesaid tips and the position of the side face of the double-sided bare chip 7 are measured constantly by the camera tools 5a and 5b.

Further, when the clip-wire unit 16 and double-sided bare chip 7 are grasped by the upper mechanical member 10 and lower mechanical member 11, it is so arranged that these are grasped with good balance and with a uniform strength in conformity with the thickness of the double-sided bare chip 7.

Next, as shown in FIG. 9B, the upper mechanical member 10 and lower mechanical member 11 are separated from each other, thereby completing the connection of the first end-face siring unit (Step N).

Next, by performing an operation similar to that of Steps J to N on the opposite side face of the double-sided bare chip 7, a clip-wire unit 16 newly set between the upper mechanical member 10 and lower mechanical member 11 is aligned with the bonding pads 8a and 8b on the double-sided bare chip 7, and the clip-wire unit 16 is connected to the bonding pads 8a and 8b while the coating of the clip-wire unit 16 is destroyed by application of heat, load, ultrasound or a combination thereof. This completes the wiring of the double-sided bare chip 7.

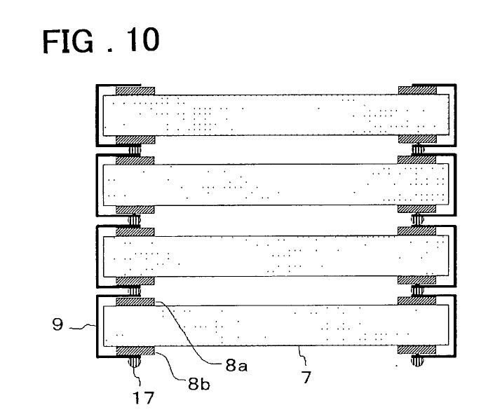

In another embodiment, as shown in FIG. 10, it is possible to obtain a stacked structure by stacking a plurality of the semiconductor devices (double-sided bare chips 7 that have been wired by the wires 9), which have been manufactured by the semiconductor manufacturing apparatus of the first to third embodiments, via connecting members such as bumps 17 interposed between corresponding ones of the bonding pads 8a and 8b. Such a stacked semiconductor device may be mounted in an electronic device such as a TAB.

The meritorious effects of the present invention are summarized as follows.

Thus, in accordance with the present invention, processes such as highly precise alignment, highly precise grinding and highly precise polishing are unnecessary in the formation of the end-face wiring on the chip end faces. As a result, it is possible to realize a highly versatile, low-cost semiconductor device having end-face wiring. The device has highly reliable connections and can be manufactured with few resources, no major technological problems and through a small number of processes.

Further, the wiring between the upper bonding pad and the corresponding lower bonding pad of every doubled-sided chip is connected by wire bonding. As a result, it is possible to obtain a highly versatile semiconductor device having end-face wiring, the device being advantageous in that thickness and weight can be reduced with almost change in the size of the chip itself.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A semiconductor manufacturing apparatus comprising:
a holder for releasably embracing and holding a substrate having first and second bonding pads on first and second surfaces thereof, respectively, said second surface being opposite the first surface;
a bonding tool for wire-bonding the first bonding pad and the second bonding pad by a wire; and
a bonding head, having said bonding tool mounted thereon, for driving said bonding tool in three dimensions and rotating the bonding tool about an axis that is perpendicular to a central axis of said bonding tool.

2. A semiconductor manufacturing apparatus comprising:
a holder for releasably embracing and holding a substrate having a top surface on which a first bonding pad is provided and a bottom surface, which is opposite the top surface, and on which a second bonding pad is provided;
a first bonding tool disposed on a side of the top surface of the substrate and having a distal end for being directed toward the substrate surface for effecting a bonding connection by a wire to the first bonding pad on the top surface of the substrate;
a second bonding tool disposed on a side of the bottom surface side of the substrate and having a distal end for being directed toward the substrate surface for effecting a bonding connection by the wire to the second bonding pad on the bottom surface of the substrate;
a first bonding head, having said first bonding tool mounted thereon, for driving said first bonding tool in three dimensions and rotating the bonding tool about an axis that is perpendicular to the central axis of said first bonding tool;
a second bonding head, having said second bonding tool mounted thereon, for driving said second bonding tool in three dimensions and rotating said second bonding tool about an axis that is perpendicular to the central axis of said second bonding tool;
a first clamper disposed above said first bonding tool for performing drive in three dimensions in association with said first bonding head, controlling feed and severing of the wire and clamping the wire, tensioned between said first and second bonding tools, in a tension-adjustable manner; and
a second clamper disposed below said second bonding tool for performing drive in three dimensions in association with said second bonding head, controlling feed and severing of the wire and clamping the wire, tensioned between said first and second bonding tools, in a tension-adjustable manner.

3. A semiconductor manufacturing apparatus comprising:
a holder for releasably embracing and holding a substrate having a top surface on which a first bonding pad is provided and a bottom surface, which is opposite the top surface, and on which a second bonding pad is provided; and
a connection tool head including:
an opening/closing mechanism for opening and closing to releasably hold a wire unit having one or more C-shaped wires, said wire unit having a recess for receiving a side end portion of the substrate;
a drive unit for driving said opening/closing mechanism in three dimensions and rotating said opening/closing mechanism about a fixed axis so as to insert the side end portion of the substrate into the recess of the wire unit until the vicinity of the bottom of the recess is reached; and
a connecting tool for effecting a bonding connection between both ends of the wire in the wire unit and corresponding ones of the first and second bonding pads on the top and bottom surfaces of the substrate.

4. The apparatus according to claim 1, wherein said wire is composed by a coated wire having a surface insulated and coated; and wherein
said bonding tool is adapted to destroy the coating of the coated wire at an electrical connecting portion thereof by energy applied when the wire is bonded.

5. The apparatus according to claim 1, wherein said holder has functions for performing heating, pressurization, drive of the held substrate along surface direction thereof and rotation about an axis perpendicular to the surface of the held substrate; and wherein
said apparatus further comprises a controller for controlling drive or functions of said bonding head, said connecting tool head or said holder under control of a predetermined program.

6. The apparatus according to claim 5, further comprising a camera tool for monitoring positions of members inclusive of the bonding pads and connection portions of the wire or distances between these members;
wherein said controller corrects trajectories or positions of said bonding head, said connecting tool head or said holder based upon video information from said camera tool.

7. The apparatus according to claim 6, wherein said controller includes generating means for generating a program for controlling operation said bonding head, said connecting tool head or said holder based upon video information from said camera tool, said camera tool imaging size of the substrate and positions of the bonding pads thereon.

8. A method of manufacturing a semiconductor device comprising the steps of:
embracing and holding a substrate having first and second bonding pads on first and second surfaces thereof, respectively;
making a first bond to the first bonding pad by a wire;
laying the wire, while tensioning the wire, from the first bonding pad to the corresponding second bonding pad on the second surface of the substrate opposite said first surface by passing the wire over the outside of a side end face of the substrate in the vicinity of the first bonding pad, and making a second bond to the second bonding pad by the wire; and
severing the wire after making the second bond.

9. A method of manufacturing a semiconductor device comprising the steps of:
embracing and holding a substrate having first and second bonding pads on first and second surfaces thereof, respectively;
bringing a tensioned wire into a contact with a side end face of the substrate, aligning one end of the wire with the first bonding pad, aligning the other end of the wire with the corresponding second bonding pad on the second surface of the substrate opposite said first surface, and bonding both ends of the wire to respective ones of the first and second bonding pads; and
severing the wire after performing bonding.

10. A method of manufacturing a semiconductor device comprising the steps of:
embracing and holding a substrate having first and second bonding pads on first and second surfaces thereof, respectively; and
inserting a side end portion of the substrate into a recess of a wire unit, which has one or more C-shaped wires, until the vicinity of the bottom of the recess is reached, aligning both ends of the wire unit with corresponding ones of the first and second bonding pads on the first and surfaces, respectively, of the substrate, and bonding the wire unit to the first and second bonding pads.

11. The apparatus according to claim 2, wherein said wire is composed by a coated wire having a surface insulated and coated; and wherein
said bonding tool is adapted to destroy the coating of the coated wire at an electrical connecting portion thereof by energy applied when the wire is bonded.

12. The apparatus according to claim 3, wherein said wire is composed by a coated wire having a surface insulated and coated; and wherein
said bonding tool is adapted to destroy the coating of the coated wire at an electrical connecting portion thereof by energy applied when the wire is bonded.

13. The apparatus according to claim 2, wherein said holder has functions for performing heating, pressurization, drive of the held substrate along surface direction thereof and rotation about an axis perpendicular to the surface of the held substrate; and wherein
said apparatus further comprises a controller for controlling drive or functions of said bonding head, said connecting tool head or said holder under control of a predetermined program.

14. The apparatus according to claim 3, wherein said holder has functions for performing heating, pressurization, drive of the held substrate along surface direction thereof and rotation about an axis perpendicular to the surface of the held substrate; and wherein
said apparatus further comprises a controller for controlling drive or functions of said bonding head, said connecting tool head or said holder under control of a predetermined program.

15. The apparatus according to claim 13, further comprising a camera tool for monitoring positions of members inclusive of the bonding pads and connection portions of the wire or distances between these members;
wherein said controller corrects trajectories or positions of said bonding head, said connecting tool head or said holder based upon video information from said camera tool.

16. The apparatus according to claim 14, further comprising a camera tool for monitoring positions of members inclusive of the bonding pads and connection portions of the wire or distances between these members;
wherein said controller corrects trajectories or positions of said bonding head, said connecting tool head or said holder based upon video information from said camera tool.

17. The apparatus according to claim 15, wherein said controller includes generating means for generating a program for controlling operation said bonding head, said connecting tool head or said holder based upon video information from said camera tool, said camera tool imaging size of the substrate and positions of the bonding pads thereon.

18. The apparatus according to claim 16, wherein said controller includes generating means for generating a program for controlling operation said bonding head, said connecting tool head or said holder based upon video information from said camera tool, said camera tool imaging size of the substrate and positions of the bonding pads thereon.
